(19) United States
(12) Patent Application Publication
(10) Pub. No.: US 2022/0221178 A1
(43) Pub. Date: Jul. 14, 2022

(54) HEATING, VENTILATION, AND AIR CONDITIONING SYSTEM CONTROL USING ADAPTIVE OCCUPANCY SCHEDULING

(71) Applicant: Lennox Industries Inc., Richardson, TX (US)

(72) Inventors: Rohini Brahme, Irving, TX (US); Sridhar Venkatesh, Irving, TX (US)

(21) Appl. No.: 17/147,199

(22) Filed: Jan. 12, 2021

(51) Int. Cl. F24F 11/46; F24F 11/62; F24F 11/64; F24F 11/65; G05B 13/02

(52) U.S. Cl. CPC F24F 11/46; F24F 11/62; F24F 2110/10; F24F 11/65; G05B 13/0265; F24F 11/64

(57) ABSTRACT

An adaptive Heating, Ventilation, and Air Conditioning (HVAC) control device configured to identify timestamps over a time period when a space is unoccupied, to identify a set point temperature for each timestamp, and to train a machine learning model using the timestamps and corresponding set point temperatures. The device is further configured to determine a timestamp that corresponds with the current day, to input the timestamp into the machine learning model, and to obtain HVAC control settings from the machine learning model in response to inputting the timestamp into the machine learning model. The HVAC control settings include a return time and a set point temperature. The device is further configured to operate the HVAC system at the set point temperature until the return time.

### TECHNICAL FIELD

The present disclosure relates generally to Heating, Ventilation, and Air Conditioning (HVAC) system control, and more specifically to HVAC system control using adaptive occupancy scheduling.

### BACKGROUND

Existing heating, ventilation, and air conditioning (HVAC) systems typically rely on a user (e.g. a homeowner) to provide scheduling information about when they will be home or away. However, some users may never provide this information to the HVAC system. Determining when a homeowner will be present or away without requiring the user to provide this information in advance poses several technical challenges because existing HVAC systems are unable to determine this information on their own. Without this information, an HVAC system is unable to provide energy-saving benefits, for example, reduced power consumption, and to reduce the wear on its components because existing HVAC systems are unable to automatically adjust set point temperatures without knowing when a user will be present. It is typically not desirable for an HVAC system to make changes to a set point temperature without knowing when a user will be present because these changes may affect the comfort level of the user.

### SUMMARY

The system disclosed in the present application provides a technical solution to the technical problems discussed above by providing an adaptive heating, ventilation, and air conditioning (HVAC) control system that is configured to predict when a user will be away from a space and when they will return to the space. By predicting when a user will be present within a space, the adaptive control system is able to provide better control and management of an HVAC system. For example, the adaptive control system may adjust the HVAC settings (e.g. set point temperature) to provide energy-saving benefits and reduced power consumption for the space while the user is away. The adaptive HVAC control system may also predict when the user will return to the space. This feature allows the adaptive HVAC control system to adjust the HVAC settings back to a comfortable level before the user returns. This process allows the adaptive HVAC control system to provide energy savings and improved resource utilization when the user is away and to maintain a comfortable environment for the user while they are present.

The disclosed system provides several practical applications and technical advantages which include a process for predicting when a user will be away and when they will return to a space. Unlike existing HVAC systems that rely on a user (e.g. a homeowner) providing scheduling information about when they will be home or away, the adaptive HVAC control system uses historical information based on the user's behavior and patterns to predict when the user will be away from the space. This process also allows the adaptive HVAC control system to learn and predict when the user will be away from the space without relying on an input from the user. This process also allows the adaptive HVAC control system to efficiently control the operation of the HVAC system based on when the user will be away from the space.

In one embodiment, the system comprises a device that is configured to train a machine learning model based on a user's behavior and patterns. For example, the device may identify timestamps over a time period when a space is unoccupied. The device also identifies a set point temperature for each timestamp. The device may then train a machine learning model using the timestamps and corresponding set point temperatures. The machine learning model is configured to receive a timestamp for the current day and/or time as an input and to output a predicted return time for a user and a set point temperature based on the timestamp. The machine learning model is trained using an occupancy history log that stored timestamps for when a user is detected within the space, timestamps for when a user is not present within the space, set point temperatures, or any other suitable type of information about a user's behavior. After the training process, the machine learning model will be configured to determine a predicted return time when a user will return to the space as well as a suitable set point temperature for the space while the user is away.

After training the machine learning model, the device may use the machine learning model to control an HVAC system. For example, the device may determine a timestamp that corresponds with the current day and/or time, input the timestamp into the machine learning model, and obtain HVAC control settings from the machine learning model in response to inputting the timestamp into the machine learning model. The HVAC control settings include a predicted return time for the user and a set point temperature for the space while the user is away. The device may then operate the HVAC system at the set point temperature until the return time.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of an adaptive control system for heating, ventilation, and air conditioning (HVAC) systems;

FIG. 2 is a flowchart of an embodiment of an adaptive control process for an HVAC system;

FIG. 3 is an embodiment of an adaptive control device for the HVAC system;

and

FIG. 4 is a schematic diagram of an embodiment of an HVAC system configured to integrate with the adaptive control system.

### DETAILED DESCRIPTION

### System Overview

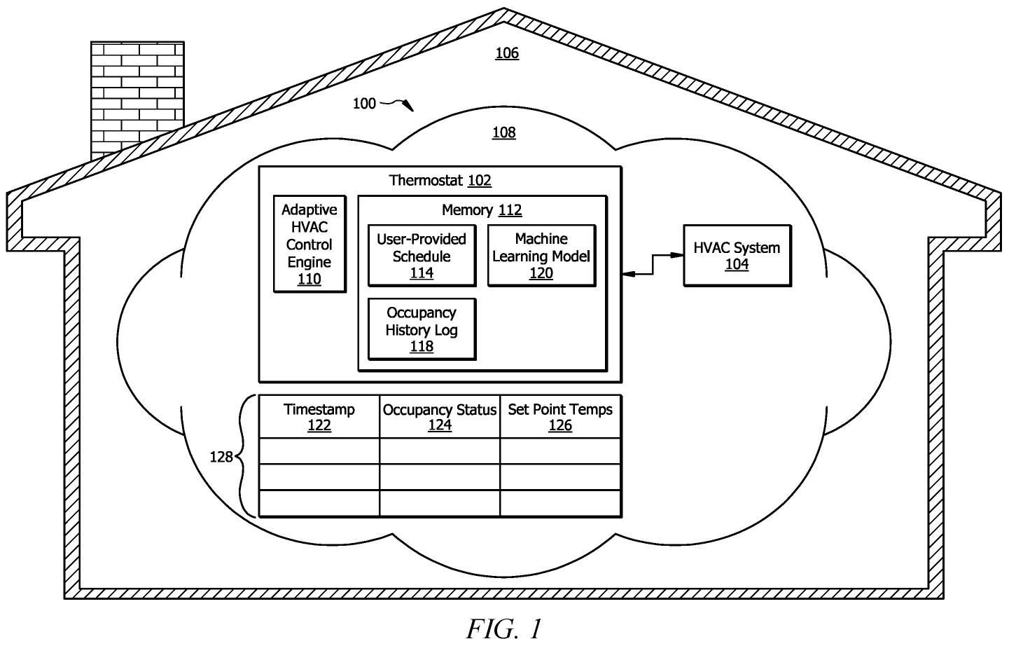

FIG. 1 is a schematic diagram of an embodiment of an adaptive control system 100 for heating, ventilation, and air conditioning (HVAC) systems 104. The adaptive control system 100 is generally configured to predict when a space 106 (e.g. a home) is unoccupied and to control an HVAC system 104 for the space 106 while the space is unoccupied to provide energy savings and improved resource utilization.

Existing HVAC systems typically rely on a user (e.g. a homeowner) to provide scheduling information about when they will be home or away. However, some users may never provide this information to the HVAC system. Determining when a homeowner will be present or away without requiring the user to provide this information in advance poses several technical challenges because existing HVAC systems are unable to determine this information on their own. Without this information, an HVAC system is unable to provide energy-saving benefits, for example, reduced power consumption, and to reduce the wear on its components because existing HVAC systems are unable to automatically adjust set point temperatures without knowing when a user will be present.

In contrast, the adaptive control system 100 is configured to predict when a user will be away from a space 106 and when they will return to the space 106. By predicting when a user will be present within a space 106, the adaptive control system 100 is able to provide better control and management of the HVAC system 104. For example, the adaptive control system 100 may adjust the HVAC settings (e.g. set point temperature) to provide energy saving benefits and reduced power consumption for the space 106 while the user is away from the space 106. The adaptive control system 100 may also predict when the user will return to the space 106. This feature allows the adaptive control system 100 to adjust the HVAC settings back to a comfortable level before the user returns. This process allows the adaptive control system 100 to provide energy savings and improved resource utilization when the user is away from a space 106 and to maintain a comfortable environment for the user while they are present within the space 106.

In one embodiment, the adaptive control system 100 comprises a thermostat 102 and an HVAC system 104 that are in signal communication with each other over a network 108. The network 108 may be any suitable type of wireless and/or wired network including, but not limited to, all or a portion of the Internet, an Intranet, a private network, a public network, a peer-to-peer network, the public switched telephone network, a cellular network, a local area network (LAN), a metropolitan area network (MAN), a personal area network (PAN), a wide area network (WAN), and a satellite network. The network 108 may be configured to support any suitable type of communication protocol as would be appreciated by one of ordinary skill in the art.

### HVAC System

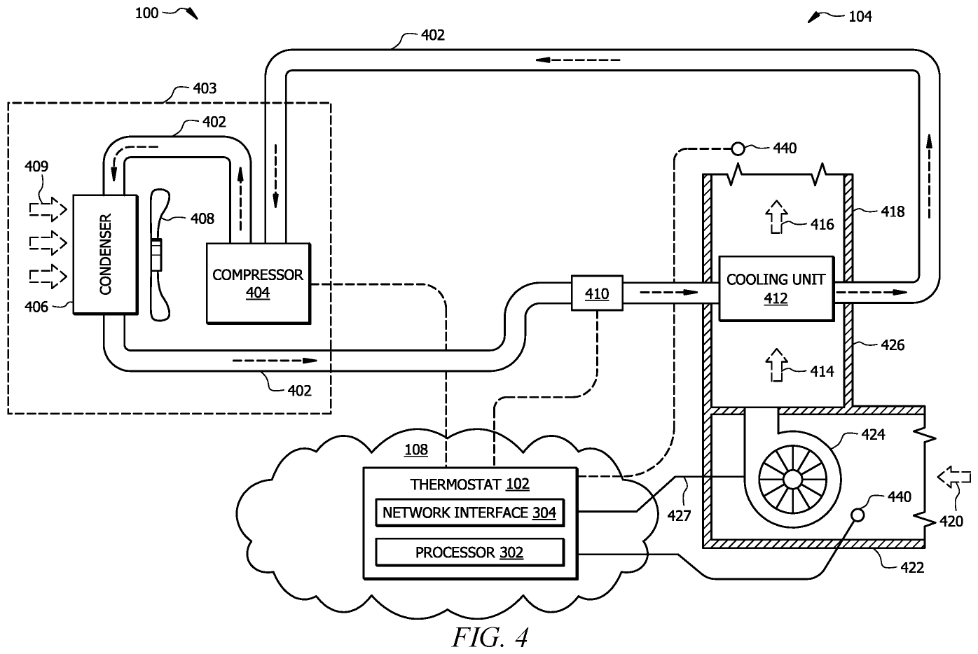

An HVAC system 104 is generally configured to control the temperature of a space 106. Examples of a space 106 include, but are not limited to, a room, a home, an apartment, a mall, an office, a warehouse, or a building. The HVAC system 104 may comprise the thermostat 102, compressors, blowers, evaporators, condensers, and/or any other suitable type of hardware for controlling the temperature of the space 106. An example of an HVAC system 104 configuration and its components are described in more detail below in FIG. 4. Although FIG. 1 illustrates a single HVAC system 104, a location or space 106 may comprise a plurality of HVAC systems 104 that are configured to work together. For example, a large building may comprise multiple HVAC systems 104 that work cooperatively to control the temperature within the building.

### Thermostat

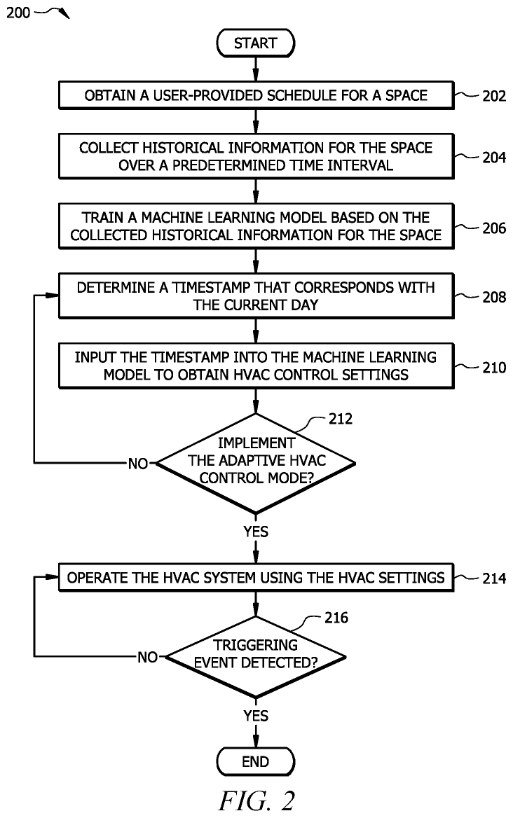

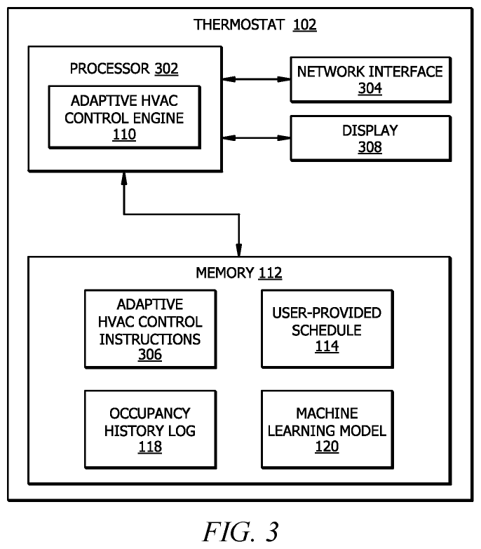

The thermostat 102 is generally configured to collect information about when a user is present within the space 106, to collect information about a user's temperature preferences, and to control the HVAC system 104 based on the collected information. An example of the thermostat 102 in operation is described below in FIG. 2. In one embodiment, the thermostat 102 comprises an adaptive HVAC control engine 110, and a memory 112. The thermostat 102 may further comprise a graphical user interface, a display, a touch screen, buttons, knobs, or any other suitable combination of components. Additional details about the hardware configuration of the thermostat 102 are described in FIG. 3.

The adaptive HVAC control engine 110 is generally configured to predict when a user will be away from a space 106 and when they will return to the space 106. By predicting when a user will be present within a space 106, the adaptive HVAC control engine 110 is able to provide better control and management of the HVAC system 104. For example, the adaptive HVAC control engine 110 may adjust the HVAC settings (e.g. set point temperature) to provide energy-saving benefits and reduced power consumption for the space 106 while the user is away. The adaptive HVAC control engine 110 may also predict when the user will return to the space 106. This feature allows the adaptive HVAC control engine 110 to adjust the HVAC settings back to a comfortable level before the user returns. This process allows the adaptive HVAC control engine 110 to provide energy savings and improved resource utilization when the user is away from a space 106 and to maintain a comfortable environment for the user while they are present within the space 106. An example of the adaptive HVAC control engine 110 in operation is described in FIG. 2.

The memory 112 is configured to store a user-provided schedule 114, an occupancy history log 118, a machine learning model 120, and/or any other suitable type of data. A user-provided schedule 114 comprises information about when a user plans to be present or away from a space 106. For example, the user-provided schedule 114 may comprise timestamps that identify days and times of the day when a user will be present or away from the space 106. The user-provided schedule 114 may further comprise user preferences such as preferred set point temperatures for the space 106. For example, the user-provided schedule 114 may associate set point temperatures with the timestamps for when the user will be present or away from the space 106. The user-provided schedule 114 allows the user to indicate their preferred set point temperatures while they are present within the space 106 as well as suitable set point temperatures while they are away from the space 106. In some embodiments, the user-provided schedule 114 may further comprise any other suitable type of information associated with the user and their preferences. A user may provide the user-provided schedule 114 to the thermostat 102 using a graphical user interface. As an example, a user may provide the user-provided schedule 114 to the thermostat 102 using a display and interface (e.g. a touchscreen) on the thermostat 102. As another example, a user may provide the user-provided schedule 114 to the thermostat 102 using a mobile device application, a computer application, or an online interface (e.g. a website). In other examples, a user may provide the user-provided schedule 114 to the thermostat 102 using any other suitable technique.

The occupancy history log 118 is generally configured to store information about the behavior of a user of the space 106. For example, the occupancy history log 118 may store timestamps for when a user is detected within the space 106, timestamps for when a user is not present within the space 106, set point temperatures, or any other suitable type of information about a user's behavior. The information in the occupancy history log 118 comprises information based on a user's actual behavior which may differ from the information provided in the user-provided schedule 114. Using the occupancy history log 118, the thermostat 102 is able to learn about the patterns and preferences of the user based on their behavior. The occupancy history log 118 comprises a plurality of entries 128. In one embodiment, each entry 128 comprises a timestamp 122, an occupancy status 124 that indicated whether a user was present or away from the space 106, and a set point temperature 126. In other examples, each entry 128 may further comprise any other suitable type or combination of information that is associated with the behavior of a user.

Examples of machine learning models 120 include, but are not limited to, a multi-layer perceptron or any other suitable type of neural network model. The machine learning models 120 are generally configured to output HVAC settings for the space 106 based on a timestamp for the current day and/or time. In one embodiment, a machine learning model 120 is configured to receive a timestamp as an input and to output a predicted return time and a set point temperature for the space 106 based on the timestamp. The machine learning model 120 is trained using the occupancy history log 118. During the training process, the machine learning model 120 determines weight and bias values for a mapping function that allows the machine learning model 120 to map a timestamp for a current day and/or time to a predicted return time and set point temperature. Through this process, the machine learning model 120 is configured to determine a predicted return time when a user will return to the space 106. The machine learning model 120 is also configured to determine a suitable set point temperature for the space 106 while the user is away. The occupancy detection engine 110 may train the machine learning model 120 using any suitable technique as would be appreciated by one of ordinary skill in the art.

### Adaptive Control Process for an HVAC System

FIG. 2 is a flowchart of an embodiment of an adaptive control process 200 for an HVAC system 104. The adaptive control system 100 may employ process 200 to predict when a space 106 (e.g. a home) is unoccupied and to control an HVAC system 104 for the space 106 while the space is unoccupied to provide energy savings and improved resource utilization. In a first phase, the adaptive control system 100 collects historical information for the space 106 that is used to train a machine learning model 120 to predict when the space 106 is unoccupied based on the behavior of a user. The historical information comprises timestamps for when a user is detected within the space 106, timestamps for when a user is not present within the space 106, and set point temperatures over a period of time. In a second phase after the machine learning model 120 is trained, the adaptive control system 100 determines a timestamp for a current day and/or time and provides the timestamp to the trained machine learning model 120 to obtain a predicted return time for the user and a set point temperature for the space 106 while the user is away. Process 200 allows the adaptive control system 100 to efficiently control the operation of the HVAC system 104 based on whether the space 106 is occupied.

### Machine Learning Model Training Phase

At step 202, the thermostat 102 obtains a user-provided schedule 114 for a space 106. The user-provided schedule 114 comprises information about when a user plans to be present or away from a space 106. For example, the user-provided schedule 114 may comprise a calendar with timestamps that identify days and times of the day when a user will be present or away from the space 106. The user-provided schedule 114 may also comprise set point temperatures for the space 106 while the user is present or away from the space 106. A user may provide the user-provided schedule 114 to the thermostat 102 using a graphical user interface. For example, a user may provide the user-provided schedule 114 using a display and interface (e.g. a touchscreen) on the thermostat 102. As another example, a user may provide the user-provided schedule 114 using a mobile device application, a computer application, or an online interface (e.g. a website). In other examples, a user may provide the user-provided schedule 114 using any other suitable technique. In some embodiments, step 202 may be optional or omitted.

At step 204, the thermostat 102 collect historical information for the space 106 over a predetermined time interval. Here, the thermostat 102 compiles information about when a user is present and away from the space 106 over a predetermined time interval. The thermostat 102 also compiles the user's preferred set point temperatures over the predetermined time interval. The predetermined time interval may be one week, two weeks, one month, two months, or any other suitable amount of time. During the predetermined time interval, the thermostat 102 populates entries 128 in the occupancy history log 118 based on the user's behavior. As an example, each entry 128 may comprise a timestamp 122, an occupancy status 124 that indicated whether a user was present or away from the space 106, and a set point temperature 126. In this example, each timestamp 112 may identify a particular day and time (e.g. an hour and/or minute). The occupancy status 124 may be a value (e.g. a Boolean value) that indicates whether a person is present or away from the space 106. For example, a Boolean value of one may indicate that the user is present within the space 106 and a Boolean value of zero may indicate that the user is away from the space 106. The thermostat 102 may determine whether the user is present within the space 106 using a proximity sensor, motion detecting sensors, or any other suitable type of sensor. The set point temperature 126 indicates the current set point temperature for the space 106. In other examples, each entry 128 may further comprise any other suitable type or combination of information that is associated with the behavior of a user.

In some embodiments, the thermostat 102 may be configured to check for weather alerts before populating an entry 128 in the occupancy history log 118. For example, the thermostat 102 may query a third-party server about the forecasted weather for the current day. The thermostat 102 may communicate with the third-party server using an application programming interface (API) or any other suitable technique. In response to sending the query, the thermostat 102 may receive information about the forecasted weather for the current day. The received weather information may comprise an indication about whether a weather alert has been forecasted for the current day. Examples of weather alerts include, but are not limited to, rainstorms, ice storms, snow, tornados, freezing temperatures, high temperatures, high winds, or any other type of inclement weather. If the received weather information comprises a weather alert, the thermostat 102 may determine to not populate an entry 128 in the occupancy history log 118 for the current day. In this case, the weather alert indicates that the current day may be an outlier which means that the user may deviate from their normal behavior patterns due to the inclement weather. By omitting the entries 128 in the occupancy history log 118 during inclement weather, the thermostat 102 is able to more accurately capture the normal behavior patterns for the user.

The information in the occupancy history log 118 comprises information based on a user's actual behavior which may differ from the information provided in the user-provided schedule 114. Using the occupancy history log 118, the thermostat 102 is able to learn about the patterns and preferences of the user based on their behavior. In one embodiment, the thermostat 102 may be configured to identify conflicts between the information in the user-provided schedule 114 and the occupancy history log 118. As an example, the thermostat 102 may identify timestamps 122 in the occupancy history log 118 that conflict with the user-provided schedule 114. For instance, a timestamp 122 may indicate that the user is away from the space 106 when the user indicated that they would be present in the user-provided schedule 114. As another example, the thermostat 102 may identify set point temperatures 126 in the occupancy history log 118 that are different from the set point temperatures provided by the user in the user-provided schedule 114. If the thermostat 102 detects a conflict between the information in the user-provided schedule 114 and the occupancy history log 118, thermostat 102 may prompt the user to reconcile the conflicts. For example, the thermostat 102 may display any identified conflicts to the user using a graphical user interface. The thermostat 102 may also request a user input to accept or change entries 128 associated with the conflicts in the occupancy history log 118. In some embodiments, the thermostat 102 may not prompt the user and may proceed with the collected information in the occupancy history log 118.

At step 206, the thermostat 102 trains a machine learning model 120 based on the collected historical information for the space 106. The thermostat 102 may use any suitable technique for training the machine learning model 120 using the occupancy history log 118 as would be appreciated by one of ordinary skill in the art. After training the machine learning model 120, the machine learning model 120 is configured to output a predicted return time and set point temperature based on a timestamp for a current day and/or time.

### Adaptive HVAC Control Phase

After training the machine learning model 120, the thermostat 102 may begin using the machine learning model 120 to predict when a user will be away from the space 106 and to adjust the HVAC settings of the HVAC system 104 to transition the HVAC system 104 to an energy-saving or low-power mode (i.e. an adaptive HVAC control mode) when the user is away from the space 106.

At step 208, the thermostat 102 determines a timestamp that corresponds with the current day and/or time. Here, the thermostat 102 determines the current day and/or time which will be used as an input for the machine learning model 120. The machine learning model 120 is configured to output HVAC settings based on the timestamp for a current day and/or time. At step 210, the thermostat 102 inputs the timestamp into the trained machine learning model 120 to obtain HVAC control settings. In one embodiment, the HVAC control settings comprise a predicted return time for the user and a set point temperature. In some embodiments, the machine learning model 120 may also output a confidence level or probability that is associated with the predicted return time and set point temperature.

At step 212, the thermostat 102 determines whether to implement the adaptive HVAC control mode. Here, the thermostat 102 may perform one or more checks to determine whether to implement the adaptive HVAC control mode using the prediction results from the machine learning model 120. In one embodiment, the thermostat 102 may determine to implement the adaptive HVAC control when the user will be away from the space 106 for at least a predetermined amount of time. For example, the thermostat 102 may determine a time difference between the current time and the predicted return time for the user. The thermostat may then compare the time difference to a time difference threshold value. The time difference threshold value identifies a minimum amount of time that the space 106 will be unoccupied to implement the adaptive HVAC control mode. The time difference threshold value may be set to four hours, six hours, eight hours, or any other suitable amount of time. In this example, the thermostat 102 determines to implement the adaptive HVAC control mode when the determined time difference is greater than or equal to the time difference threshold value.

In some embodiments, the thermostat 102 may also consider weather information when determining whether to implement the adaptive HVAC control mode. For example, the thermostat 102 may query a third-party server about the forecasted weather for the current day. In response to sending the query, the thermostat 102 receives information about the forecasted weather for the current day. The received weather information may comprise an indication about whether a weather alert has been forecasted. In this example, the thermostat 102 may determine to implement the adaptive HVAC control mode when a weather alert is not forecasted for the current day. When a weather alert is forecasted for the current day, the thermostat 102 may determine to not implement the adaptive HVAC control mode since the user's typical behavior may change because of the weather. In other embodiments, the thermostat 102 may use any other suitable type or combination of criteria for determining whether to implement the adaptive HVAC control mode.

The thermostat 102 returns to step 208 in response to determining not to implement the adaptive HVAC control mode. In this case, will return to step 208 to wait until a later time to check again whether to implement the adaptive HVAC control mode. For example, the thermostat 102 may wait for twelve hours or twenty-fours before checking again whether to implement the adaptive HVAC control mode based on a new timestamp. In other examples, the thermostat 102 may wait for any other suitable amount of time before checking again whether to implement the adaptive HVAC control mode.

The thermostat 102 proceeds to step 214 in response to determining to implement the adaptive HVAC control mode. At step 214, the thermostat 102 controls the HVAC system 104 using the HVAC control settings until the predicted return time for the user. For example, the thermostat 102 may send commands or instructions to the HVAC system 104 to operate the HVAC system 104 at the set point temperature that was provided by the machine learning model 120 in step 210. This process allows the thermostat 102 to operate the HVAC system 104 in an energy-saving or low-power mode while the user is away from the space 106.

In some embodiments, the thermostat 102 may be further configured to determine a transition time that occurs before when the user is expected to return to the space 106. The transition time is an amount of time that will be used to transition the adjusted set point temperature back to a user-preferred set point temperature before the user returns to the space 106. For example, thermostat 102 may increase the temperature within the space 106 while the user is away. In this example, the thermostat 102 will then reduce the temperature back to a comfortable temperature before the user returns to the space 106. The transition time may be set to thirty minutes, one hour, or any suitable amount of time before when the user is expected to return to the space 106. Thermostat 102 may use information from the user-provided schedule 114 and/or the occupancy history log 118 to determine a new set point temperature based on the user's preferences. For example, the thermostat 102 may use the timestamp for the predicted return time for the user to identify a similar timestamp within the user-provided schedule 114 and/or the occupancy history log 118. The thermostat 102 may then identify a new set point temperature that corresponds with the matching timestamp. The thermostat 102 may then send commands or instructions to the HVAC system 104 to operate the HVAC system 104 at the new set point temperature starting at the transition time.

While the thermostat 102 is implementing the adaptive HVAC control mode, the thermostat 102 periodically checks whether any triggering events have been detected for exiting the adaptive HVAC control mode. At step 216, the thermostat 102 determines whether any triggering events have been detected for aborting the adaptive HVAC control mode. As an example, a triggering event may be detecting the presence of the user within a predetermined distance of the space 106. In this example, the thermostat 102 may use a geofence or Global Positioning System (GPS) information to determine whether the user is within the predetermined distance of the space 106. For instance, a user device (e.g. a smartphone) that is associated with the user may be configured to periodically provide location information (e.g. a GPS coordinate) to the thermostat 102. The thermostat 102 determines a distance between the location of the space 106 and the current location of the user to determine whether the user is within the predetermined distance of the space 106. The predetermined distance of the space 106 may be set to one mile, two miles, five miles, or any other suitable distance.

As another example, a triggering event may be detecting a user device that is associated with a user has joined a wireless network (e.g. a WiFi network) that is associated with the space 106. In this example, the thermostat 102 may be configured to periodically receive information from an access point about the devices that are currently connected to a wireless network for the space 106. The thermostat 102 may compare an identifier for a known user device (e.g. a smartphone) to the list of devices that are currently connected to the access point to determine whether the user is present. The thermostat 102 determines that the user is present at the space 106 when the known user device matches one of the devices in the list of devices that are currently connected to the access point.

As another example, a triggering event may be detecting the presence of the user within the space 106. In this example, the thermostat 102 may use proximity sensors, motion detection sensors, door sensors, or any other suitable type of sensors to detect the presence of the user. In other examples, the thermostat 102 may use any other suitable type or combination of triggering events for determining whether to abort the adaptive HVAC control mode.

The thermostat 102 returns to step 214 in response to determining that no triggering events have been detected for aborting the adaptive HVAC control mode. In this case, the thermostat 102 will continue using the current HVAC settings until the predicted return time for the user or a determined transition time is reached or until a triggering event has been detected.

Otherwise, the thermostat 102 will terminate process 200 in response to detecting a triggering event for aborting the adaptive HVAC control mode. In this case, the thermostat 102 will exit the adaptive occupancy mode and resume normal operation of the HVAC system 104 using the previous user-provided settings (e.g. set point temperature). Here, the thermostat 102 adjusts the temperature back to a comfortable temperature for the user. For example, the thermostat 102 may use a process similar to the process described in step 214 to determine a new set point temperature for the user and to operate the HVAC system 104 based on the new set point temperature.

### Hardware Configuration for an Adaptive Control Device

FIG. 3 is an embodiment of an adaptive control device (e.g. thermostat 102) of an adaptive control system 100. As an example, the thermostat 102 comprises a processor 302, a memory 112, a display 308, and a network interface 304. The thermostat 102 may be configured as shown or in any other suitable configuration.

### Processor

The processor 302 comprises one or more processors operably coupled to the memory 112. The processor 302 is any electronic circuitry including, but not limited to, state machines, one or more central processing unit (CPU) chips, logic units, cores (e.g. a multi-core processor), field-programmable gate array (FPGAs), application-specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 112, the display 308, and the network interface 304. The one or more processors are configured to process data and may be implemented in hardware or software. For example, the processor 302 may be 8-bit, 16-bit, 32-bit, 64-bit, or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute adaptive HVAC control instructions 306 to implement the adaptive HVAC control engine 110. In this way, processor 302 may be a special-purpose computer designed to implement the functions disclosed herein. In an embodiment, the adaptive HVAC control engine 110 is implemented using logic units, FPGAs, ASICs, DSPs, or any other suitable hardware. The adaptive HVAC control engine 110 is configured to operate as described in FIGS. 1 and 2. For example, the adaptive HVAC control engine 110 may be configured to perform the steps of process 200 as described in FIG. 2.

### Memory

The memory 112 is operable to store any of the information described above with respect to FIGS. 1 and 2 along with any other data, instructions, logic, rules, or code operable to implement the function(s) described herein when executed by the processor 302. The memory 112 comprises one or more disks, tape drives, or solid-state drives, and may be used as an over-flow data storage device, to store programs when such programs are selected for execution, and to store instructions and data that are read during program execution. The memory 112 may be volatile or non-volatile and may comprise a read-only memory (ROM), random-access memory (RAM), ternary content-addressable memory (TCAM), dynamic random-access memory (DRAM), and static random-access memory (SRAM).

The memory 112 is operable to store adaptive HVAC control instructions 306, user-provided schedules 114, occupancy history logs 118, machine learning models 120, and/or any other data or instructions. The adaptive HVAC control instructions 306 may comprise any suitable set of instructions, logic, rules, or code operable to execute the adaptive HVAC control engine 110. The user-provided schedules 114, the occupancy history logs 118, and the machine learning models 120 are configured similar to the user-provided schedules 114, the occupancy history logs 118, and the machine learning models 120 described in FIGS. 1-2.

### Display

The display 308 is configured to present visual information to a user using graphical objects. Examples of the display 308 include, but are not limited to, a liquid crystal display (LCD), a liquid crystal on silicon (LCOS) display, a light-emitting diode (LED) display, an active-matrix OLED (AMOLED), an organic LED (OLED) display, a projector display, or any other suitable type of display as would be appreciated by one of ordinary skill in the art.

### Network Interface

The network interface 304 is configured to enable wired and/or wireless communications. The network interface 304 is configured to communicate data between the thermostat 102 and other devices (e.g. the HVAC system 104), systems, or domains. For example, the network interface 304 may comprise an NFC interface, a Bluetooth interface, a Zigbee interface, a Z-wave interface, an RFID interface, a WIFI interface, a LAN interface, a WAN interface, a PAN interface, a modem, a switch, or a router. The processor 302 is configured to send and receive data using the network interface 304. The network interface 304 may be configured to use any suitable type of communication protocol as would be appreciated by one of ordinary skill in the art.

### HVAC System Configuration

FIG. 4 is a schematic diagram of an embodiment of an HVAC system 104 configured to integrate with an adaptive control system 100. The HVAC system 104 conditions air for delivery to an interior space of a building or home. In some embodiments, the HVAC system 104 is a rooftop unit (RTU) that is positioned on the roof of a building and the conditioned air is delivered to the interior of the building. In other embodiments, portions of the system may be located within the building and a portion outside the building. The HVAC system 104 may also include heating elements that are not shown here for convenience and clarity. The HVAC system 104 may be configured as shown in FIG. 4 or in any other suitable configuration. For example, the HVAC system 104 may include additional components or may omit one or more components shown in FIG. 4.

The HVAC system 104 comprises a working-fluid conduit subsystem 402 for moving a working fluid, or refrigerant, through a cooling cycle. The working fluid may be any acceptable working fluid, or refrigerant, including, but not limited to, fluorocarbons (e.g. chlorofluorocarbons), ammonia, non-halogenated hydrocarbons (e.g. propane), hydrofluorocarbons (e.g. R-410A), or any other suitable type of refrigerant.

The HVAC system 104 comprises one or more condensing units 403. In one embodiment, the condensing unit 403 comprises a compressor 404, a condenser coil 406, and a fan 408. The compressor 404 is coupled to the working-fluid conduit subsystem 402 that compresses the working fluid. The condensing unit 403 may be configured with a single-stage or multi-stage compressor 404. A single-stage compressor 404 is configured to operate at a constant speed to increase the pressure of the working fluid to keep the working fluid moving along the working-fluid conduit subsystem 402. A multi-stage compressor 404 comprises multiple compressors configured to operate at a constant speed to increase the pressure of the working fluid to keep the working fluid moving along the working-fluid conduit subsystem 402. In this configuration, one or more compressors can be turned on or off to adjust the cooling capacity of the HVAC system 104. In some embodiments, a compressor 404 may be configured to operate at multiple speeds or as a variable speed compressor. For example, the compressor 404 may be configured to operate at multiple predetermined speeds.

In one embodiment, the condensing unit 403 (e.g. the compressor 404) is in signal communication with a controller or thermostat 102 using a wired or wireless connection. The thermostat 102 is configured to provide commands or signals to control the operation of the compressor 404. For example, the thermostat 102 is configured to send signals to turn on or off one or more compressors 404 when the condensing unit 403 comprises a multi-stage compressor 404. In this configuration, the thermostat 102 may operate the multi-stage compressors 404 in a first mode where all the compressors 404 are on and a second mode where at least one of the compressors 404 is off. In some examples, the thermostat 102 may be configured to control the speed of the compressor 404.

The condenser 406 is configured to assist with moving the working fluid through the working-fluid conduit subsystem 402. The condenser 406 is located downstream of the compressor 404 for rejecting heat. The fan 408 is configured to move air 409 across the condenser 406. For example, the fan 408 may be configured to blow outside air through the heat exchanger to help cool the working fluid. The compressed, cooled working fluid flows downstream from the condenser 406 to an expansion device 410, or metering device.

The expansion device 410 is configured to remove pressure from the working fluid. The expansion device 410 is coupled to the working-fluid conduit subsystem 402 downstream of the condenser 406. The expansion device 410 is closely associated with a cooling unit 412 (e.g. an evaporator coil). The expansion device 410 is coupled to the working-fluid conduit subsystem 402 downstream of the condenser 406 for removing pressure from the working fluid. In this way, the working fluid is delivered to the cooling unit 412 and receives heat from airflow 414 to produce a treated airflow 416 that is delivered by a duct subsystem 418 to the desired space, for example, a room in the building.

A portion of the HVAC system 104 is configured to move air across the cooling unit 412 and out of the duct sub-system 418. Return air 420, which may be air returning from the building, fresh air from outside, or some combination, is pulled into a return duct 422. A suction side of a variable-speed blower 424 pulls the return air 420. The variable-speed blower 424 discharges airflow 414 into a duct 426 from where the airflow 414 crosses the cooling unit 412 or heating elements (not shown) to produce the treated airflow 416.

Examples of a variable-speed blower 424 include, but are not limited to, belt-drive blowers controlled by inverters, direct-drive blowers with electronically commutated motors (ECM), or any other suitable types of blowers. In some configurations, the variable-speed blower 424 is configured to operate at multiple predetermined fan speeds. In other configurations, the fan speed of the variable-speed blower 424 can vary dynamically based on a corresponding temperature value instead of relying on using predetermined fan speeds. In other words, the variable-speed blower 424 may be configured to dynamically adjust its fan speed over a range of fan speeds rather than using a set of predetermined fan speeds. This feature also allows the thermostat 102 to gradually transition the speed of the variable-speed blower 424 between different operating speeds. This contrasts with conventional configurations where a variable-speed blower 424 is abruptly switched between different predetermined fan speeds. The variable-speed blower 424 is in signal communication with the thermostat 102 using any suitable type of wired or wireless connection 427. The thermostat 102 is configured to provide commands or signals to the variable-speed blower 424 to control the operation of the variable-speed blower 424. For example, the thermostat 102 is configured to send signals to the variable-speed blower 424 to control the fan speed of the variable-speed blower 424. In some embodiments, the thermostat 102 may be configured to send other commands or signals to the variable-speed blower 424 to control any other functionality of the variable-speed blower 424.

The HVAC system 104 comprises one or more sensors 440 in signal communication with the thermostat 102. The sensors 440 may comprise any suitable type of sensor for measuring the air temperature. The sensors 440 may be positioned anywhere within a conditioned space (e.g. a room or building) and/or the HVAC system 104. For example, the HVAC system 104 may comprise a sensor 440 positioned and configured to measure an outdoor air temperature. As another example, the HVAC system 104 may comprise a sensor 440 positioned and configured to measure a supply or treated air temperature and/or a return air temperature. In other examples, the HVAC system 104 may comprise sensors 440 positioned and configured to measure any other suitable type of air temperature.

The HVAC system 104 comprises one or more thermostats 102, for example, located within a conditioned space (e.g. a room or building). A thermostat 102 may be a single-stage thermostat, a multi-stage thermostat, or any suitable type of thermostat as would be appreciated by one of ordinary skill in the art. The thermostat is configured to allow a user to input a desired temperature or temperature set point for a designated space or zone such as the room.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An adaptive Heating, Ventilation, and Air Conditioning (HVAC) control device, comprising:
a network interface operably coupled to an HVAC system, wherein the HVAC system is configured to control a temperature of a space; and
a processor operably coupled to the network interface, configured to:
identify a plurality of timestamps over a predetermined time period when a space is unoccupied;
identify a set point temperature for each timestamp, wherein the set point temperature is a temperature within the space when the space is unoccupied;
train a machine learning model using the plurality of timestamps and corresponding set point temperatures, wherein:
the machine learning model is configured to:
receive a first timestamp as an input; and
determine HVAC control settings based on the first timestamp, wherein the HVAC control settings comprise a predicted return time and a set point temperature;
determine a current day;
determine a second timestamp that corresponds with the current day;
input the second timestamp into the machine learning model:
obtain HVAC control settings from the machine learning model in response to inputting the second timestamp into the machine learning model, wherein the HVAC control settings comprise a second return time and a second set point temperature; and
operate the HVAC system at the second set point temperature until the second return time.

2. The device of claim 1, wherein the processor is further configured to:
determine a current time;
determine a time difference between the second return time and the current time;
compare the time difference to a time difference threshold value, wherein the time difference threshold value identifies a minimum amount of time that the space will be unoccupied;
determine that the time difference is greater than the time difference threshold value; and
operate the HVAC system at the second set point temperature in response to determining that the time difference is greater than the time difference threshold value.

3. The device of claim 1, wherein the processor is further configured to:
identify a transition time that occurs before the second return time;
determine a third set point temperature, wherein the third set point temperature is a temperature within the space when the space is occupied; and
operate the HVAC system at the third set point temperature at the transition time.

4. The device of claim 1, wherein the processor is further configured to:
determine a person has entered the space while operating the HVAC system at the second set point temperature;
determine a third set point temperature, wherein the third set point temperature is a temperature within the space when the space is occupied; and
operate the HVAC system at the third set point temperature.

5. The device of claim 1, wherein the processor is further configured to:
determine a person is within a predetermined distance of the space while operating the HVAC system at the second set point temperature;
determine a third set point temperature, wherein the third set point temperature is a temperature within the space when the space is occupied; and
operate the HVAC system at the third set point temperature.

6. The device of claim 1, wherein the processor is further configured to:
detect a user device that is associated with a person has joined a wireless network that is associated with the space;
determine a third set point temperature, wherein the third set point temperature is a temperature within the space when the space is occupied; and
operate the HVAC system at the third set point temperature.

7. The device of claim 1, wherein the processor is further configured:
obtain weather information for the current day;
determine a weather alert is not present before operating the HVAC system at the second set point temperature.

8. An adaptive Heating, Ventilation, and Air Conditioning (HVAC) control method, comprising:
identifying a plurality of timestamps over a predetermined time period when a space is unoccupied;
identifying a set point temperature for each timestamp, wherein the set point temperature is a temperature within the space when the space is unoccupied;
training a machine learning model using the plurality of timestamps and corresponding set point temperatures, wherein:
the machine learning model is configured to:
receive a first timestamp as an input; and
determine HVAC control settings based on the first timestamp,
wherein the HVAC control settings comprise a predicted return time and a set point temperature;
determine a current day;
determine a second timestamp that corresponds with the current day;
inputting the second timestamp into the machine learning model:
obtaining HVAC control settings from the machine learning model in response to inputting the second timestamp into the machine learning model, wherein the HVAC control settings comprise a second return time and a second set point temperature; and
operating the HVAC system at the second set point temperature until the second return time.

9. The method of claim 8, further comprising:
determining a current time;
determining a time difference between the second return time and the current time;
comparing the time difference to a time difference threshold value, wherein the time difference threshold value identifies a minimum amount of time that the space will be unoccupied;
determining that the time difference is greater than the time difference threshold value; and
operating the HVAC system at the second set point temperature in response to determining that the time difference is greater than the time difference threshold value.

10. The method of claim 8, further comprising:
identifying a transition time that occurs before the second return time;
determining a third set point temperature, wherein the third set point temperature is a temperature within the space when the space is occupied; and
operating the HVAC system at the third set point temperature at the transition time.

11. The method of claim 8, further comprising:
determining a person has entered the space while operating the HVAC system at the second set point temperature;
determining a third set point temperature, wherein the third set point temperature is a temperature within the space when the space is occupied; and
operating the HVAC system at the third set point temperature.

12. The method of claim 8, further comprising:
determining a person is within a predetermined distance of the space while operating the HVAC system at the second set point temperature;
determining a third set point temperature, wherein the third set point temperature is a temperature within the space when the space is occupied; and
operating the HVAC system at the third set point temperature.

13. The method of claim 8, further comprising:
detecting a user device that is associated with a person has joined a wireless network that is associated with the space;
determining a third set point temperature, wherein the third set point temperature is a temperature within the space when the space is occupied; and
operating the HVAC system at the third set point temperature.

14. The method of claim 8, further comprising:
obtaining weather information for the current day;
determining a weather alert is not present before operating the HVAC system at the second set point temperature.

15. A computer program comprising executable instructions stored in a non-transitory computer-readable medium that when executed by a processor causes the processor to:
identify a plurality of timestamps over a predetermined time period when a space is unoccupied;
identify a set point temperature for each timestamp, wherein the set point temperature is a temperature within the space when the space is unoccupied;
train a machine learning model using the plurality of timestamps and corresponding set point temperatures, wherein:
the machine learning model is configured to:
receive a first timestamp as an input; and
determine Heating, Ventilation, and Air Conditioning (HVAC) control settings based on the first timestamp, wherein the HVAC control settings comprise a predicted return time and a set point temperature;
determine a current day;
determine a second timestamp that corresponds with the current day;
input the second timestamp into the machine learning model:
obtain HVAC control settings from the machine learning model in response to inputting the second timestamp into the machine learning model, wherein the HVAC control settings comprise a second return time and a second set point temperature; and
operate the HVAC system at the second set point temperature until the second return time.

16. The computer program of claim 15, further comprising instructions that when executed by the processor causes the processor to:
determine a current time;
determine a time difference between the second return time and the current time;
compare the time difference to a time difference threshold value, wherein the time difference threshold value identifies a minimum amount of time that the space will be unoccupied;
determine that the time difference is greater than the time difference threshold value; and
operate the HVAC system at the second set point temperature in response to determining that the time difference is greater than the time difference threshold value.

17. The computer program of claim 15, further comprising instructions that when executed by the processor causes the processor to:
identify a transition time that occurs before the second return time;
determine a third set point temperature, wherein the third set point temperature is a temperature within the space when the space is occupied; and
operate the HVAC system at the third set point temperature at the transition time.

18. The computer program of claim 15, further comprising instructions that when executed by the processor causes the processor to:
determine a person is within a predetermined distance of the space while operating the HVAC system at the second set point temperature;
determine a third set point temperature, wherein the third set point temperature is a temperature within the space when the space is occupied; and
operate the HVAC system at the third set point temperature.

19. The computer program of claim 15, further comprising instructions that when executed by the processor causes the processor to:
detect a user device that is associated with a person has joined a wireless network that is associated with the space;
determine a third set point temperature, wherein the third set point temperature is a temperature within the space when the space is occupied; and
operate the HVAC system at the third set point temperature.

20. The computer program of claim 15, further comprising instructions that when executed by the processor causes the processor to:
obtain weather information for the current day;
determine a weather alert is not present before operating the HVAC system at the second set point temperature.
